(19) United States
(12) Patent Application Publication
(10) Pub. No.: US 2009/0102773 A1
(43) Pub. Date: Apr. 23, 2009

(54) LIQUID CRYSTAL DISPLAY

(76) Inventors: Yoon-Sung UM, Yongin-si (KR); Jae-Jin LYU, Yongin-si (KR)

Correspondence Address: MACPHERSON KWOK CHEN & HEID LLP, 2033 GATEWAY PLACE, SUITE 400, SAN JOSE, CA, 95110, US

(21) Appl. No.: 12/168,622

(22) Filed: Jul. 7, 2008

(30) Foreign Application Priority Data
Oct. 22, 2007 (KR) 10-2007-0106108

(51) Int. Cl. G09G 3/34

(52) U.S. Cl. 345/92

(57) ABSTRACT

A liquid crystal display (LCD) includes thin film transistors (TFTs) respectively coupled to different gate lines and to a pixel electrode and a direction control electrode, and to which different gate-off voltages are respectively applied. Alternatively, a reduced gate voltage is applied to the pixel electrode TFT according to a coupling capacitance. Alternatively, the pixel and direction control TFTs are coupled to the same gate line, and portions of a gate insulating layer are formed with different thicknesses. Resulting differences in the voltages respectively applied to the two TFTs or in the electric fields respectively applied to the two electrodes prevent leakage current of the direction control electrode TFT, thereby enabling stable multi-domains to be implemented in the LCD without applying a high voltage.

### RELATED APPLICATIONS

This application claims priority of Korean Patent Application No. 10-2007-0106108, filed Oct. 22, 2007, the entire disclosure of which is incorporated herein by reference.

### BACKGROUND

This disclosure relates to display devices, and more particularly, to liquid crystal displays (LCDs) having direction control electrodes.

An LCD typically includes a thin film transistor substrate that includes a pixel electrode, a color filter substrate that includes a common electrode, and a layer of a liquid crystal material interposed between the two substrates. The molecules of the liquid crystal layer are realigned by applying a voltage to the pixel electrode and the common electrode, and the amount of light passing through the liquid crystal layer is thereby controlled to display an image.

A variety of methods have been proposed for providing wider viewing angles in LCDs. These include methods in which slit patterns or protrusions are formed at a pixel electrode and a common electrode of the LCD to form so-called “fringe fields,” so that orientations of liquid crystal molecules disposed therein are evenly distributed.

However, these slit patterns and/or protrusions result in a decrease in the aperture ratio of the LCD. Also, in forming the slit patterns, additional photolithography processes are needed to form the slit patterns at both the pixel electrode and the common electrode. Accordingly, the number of processes and devices required in the manufacture of an LCD increases, which results in an concomitant increase of LCD processing cost and time.

Another method has been proposed of forming a direction control electrode on a thin film transistor substrate for controlling the orientations of the liquid crystal molecules. In this method, a direction control electrode, a pixel electrode, a first thin film transistor for the pixel electrode, and a second thin film transistor for the direction control electrode are disposed on the thin film transistor substrate. The first and second thin film transistors are turned on/off by the same gate-on and gate-off voltages. In LCDs having direction control electrodes, the respective pixel electrodes and the common electrode constitute a liquid crystal capacitor having a liquid crystal layer therebetween, and the respective direction control electrodes and the common electrode constitute a direction control capacitor having a liquid crystal layer therebetween.

In order to implement multi-domains in a pixel of an LCD in which the molecules of the liquid crystal layer are respectively aligned in different directions by the electric field of the direction control electrode, the capacitance of the direction control capacitor must be higher than the capacitance of the liquid crystal capacitor. That is, the absolute value of the voltage difference between the direction control electrode and the common electrode must be greater than that between the pixel electrode and the common electrode.

For example, in order to operate a pixel as four separate domains, in the case in which the same voltage is applied to the common electrode, the voltage applied to the direction control electrode should be greater than the voltage applied to the pixel electrode by +5V in a positive (+) state thereof. In a negative (−) state, the voltage applied to the direction control electrode should be greater than that applied to the pixel electrode by −5V. Thus, if voltages applied to the pixel electrode in the positive and negative states are 12V and 0V, respectively, voltages of 17V and −5V should be applied to the direction control electrode, respectively. At this point, the gate-on voltage Von and the gate-off voltage Voff would be approximately 25V and −7V, respectively. If the gate-off voltage Voff is −7V, a difference between the voltages applied to the direction control electrode and the gate-off voltage Voff is 24V in the positive state, and 2V in the negative state.

When the difference between the voltages applied to the direction control electrode and the gate-off voltage is sufficiently large, no leakage current will flow through the channel of the associated second thin film transistor. However, as the voltage difference becomes smaller, the leakage current flowing through the channel increases. For example, if a voltage of −5V is applied to the direction control electrode and a gate-off voltage Voff of −7V is applied to the second thin film transistor in the negative state, the electric charge of the direction control capacitor leaks through the channel of the second thin film transistor.

As a result of this charge leakage, the direction control capacitor can not be charged with an electric charge that is sufficient to implement multi-domains in the pixel, thereby preventing the pixel from being divided into multi-domains.

### SUMMARY

In accordance with the present disclosure, liquid crystal displays (LCDs) are provided that are configured to prevent the occurrence of leakage current in the direction control thin film transistors thereof.

The present disclosure also provides LCDs that are configured to prevent leakage current in a second thin film transistor by respectively implementing a first thin film transistor for a pixel electrode and a second thin film transistor for a direction control electrode on different gate lines and by applying different gate-off voltages thereto.

The present disclosure also provides LCDs that are configured to prevent leakage current in a second thin film transistor by implementing a second gate electrode of the second thin film transistor for a direction control electrode on a gate line, and implementing a first gate electrode of a first thin film transistor for a pixel electrode as a coupling capacitor with the gate line, so that a lower voltage can be applied to the first gate electrode than to the second gate electrode.

The present disclosure also provides LCDs that are configured to prevent leakage current in a second thin film transistor by implementing a first thin film transistor for a pixel electrode and the second thin film transistor for a direction control electrode on the same gate line, and by making respective gate insulating layers of the first and second thin film transistors have different thicknesses.

In accordance with one exemplary embodiment, an LCD includes: parallel first and second gate lines extending in a first direction; a data line extending in a direction so as to intersect the first and second gate lines; a pixel electrode disposed at the intersection of the first gate line and the data line; a direction control electrode insulated from the pixel electrode; a first thin film transistor connected to the first gate line, the data line and the pixel electrode; and a second thin film transistor connected to the second gate line, the data line and the direction control electrode, wherein different gate signals are applied to the first and second gate lines.

In accordance with another exemplary embodiment, an LCD includes: a gate line extending in a first direction; a data line extending in a direction so as to intersect the gate line; a pixel electrode disposed at the intersection of the gate line and the data line; a direction control electrode insulated from the pixel electrode; a first thin film transistor connected to the gate line as a coupling capacitor; and a second thin film transistor connected to the gate line.

In accordance with another exemplary embodiment, an LCD includes: a gate line extending in one direction; a data line extending in a direction so as to intersect the gate lines; a pixel electrode disposed at the intersection of the gate line and the data line; a direction control electrode insulated from the pixel electrode; a first thin film transistor connected to the gate line, the data line and the pixel electrode, and including a gate insulating layer having a first thickness; and, a second thin film transistor connected to the gate line, the data line and the direction control electrode, and including a gate insulating layer having a second thickness, wherein the first and second gate insulating layer thicknesses are different from each other.

In accordance with another exemplary embodiment, an LCD includes: a gate line extending in a first direction; a data line extending in a direction so as to intersect the gate lines; a pixel electrode disposed the intersection of the gate line and the data line; a direction control electrode insulated from the pixel electrode; a first thin film transistor connected to the gate line, the data line and the pixel electrode; and a second thin film transistor connected to the gate line, the data line and the direction control electrode, wherein the absolute value of a gate signal applied to the second thin film transistor is higher than the absolute value of a gate signal applied to the first thin film transistor.

A better understanding of the above and many other features and advantages of the novel LCDs of the present disclosure may be obtained from a consideration of the detailed description of some exemplary embodiments thereof below, particularly if such consideration is made in conjunction with the several views of the appended drawings, wherein like elements are referred to by like reference numerals throughout.

### BRIEF DESCRIPTION OF THE DRAWINGS

FIG. 1 is a partial plan view of an exemplary embodiment of an LCD panel in accordance with the present disclosure, showing a single exemplary pixel area thereof;

FIG. 2 is a partial cross-sectional view of the LCD panel of FIG. 1, as seen along the lines of the section I-I′ taken therein;

FIG. 3 is an enlarged plan view of a slit pattern of a pixel electrode of the LCD panel of FIG. 1;

FIG. 4 is a functional block diagram of a device for driving the LCD panel of FIG. 1;

FIG. 5 is an equivalent circuit diagram of the single pixel of the LCD panel of FIG. 1;

FIG. 6 is a timing diagram for driving the LCD panel of FIG. 1;

FIG. 7 is a partial plan view of a second exemplary embodiment of an LCD panel in accordance with the present disclosure, showing a single exemplary pixel area thereof;

FIG. 8 is a partial cross-sectional view of the LCD panel of FIG. 7, as seen along the lines of the section II-II′ taken therein;

FIG. 9 is a partial cross-sectional view of the LCD panel of FIG. 7, as seen along the lines of the section III-III′ taken therein;

FIG. 10 is a partial cross-sectional view of the LCD panel of FIG. 7, as seen along the lines of the section IV-IV′ taken therein;

FIG. 11 is a partial plan view of a third exemplary embodiment of an LCD panel in accordance with the present disclosure, showing a single exemplary pixel area thereof;

FIG. 12 is a partial cross-sectional view of the LCD panel of FIG. 11, as seen along the lines of the section V-V′ taken therein;

FIG. 13 is a partial cross-sectional view of the LCD panel of FIG. 11, as seen along the lines of the section VI-VI′ taken therein; and,

FIG. 14 is a partial cross-sectional view of the LCD panel of FIG. 11, as seen along the lines of the section VII-VII′ taken therein.

### DETAILED DESCRIPTION

Hereinafter, specific exemplary embodiments of the present disclosure will be described in detail with reference to the accompanying drawings. However, it should be understood that the present invention may be embodied in different forms, and accordingly, should not be construed as being limited to the particular embodiments set forth herein. Rather, these embodiments are provided by way of some examples of this invention, so that this disclosure will be thorough and complete and will fully convey the scope of the present invention to those skilled in the art.

First Exemplary Embodiment 1

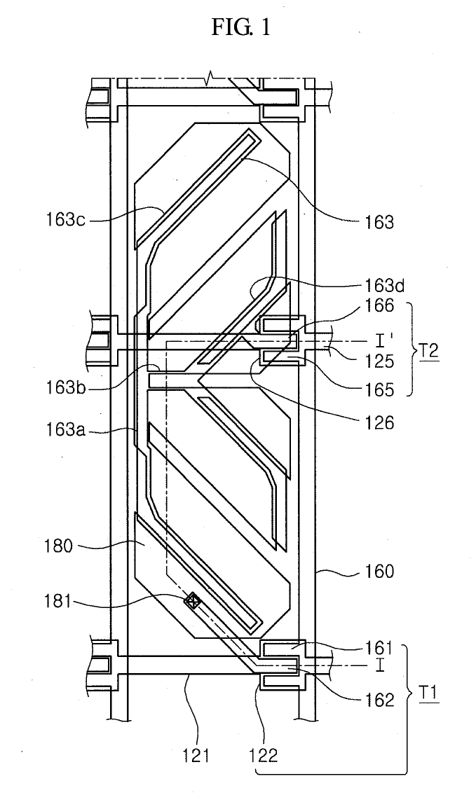

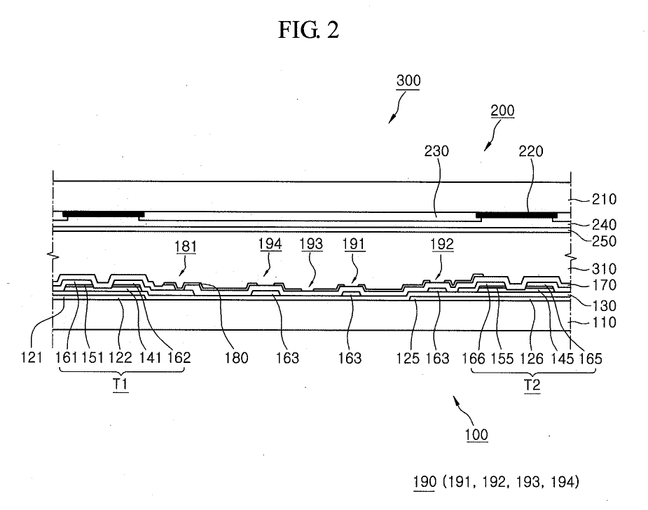

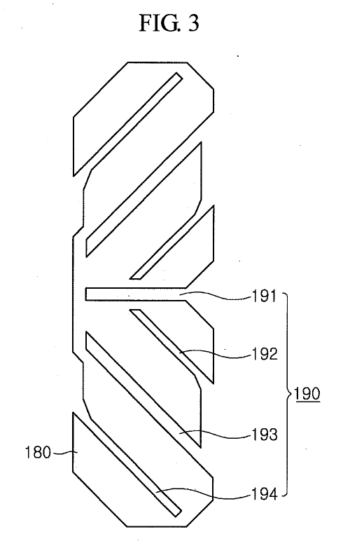

FIG. 1 is a partial plan view of a first exemplary embodiment of an LCD panel 300 in accordance with the present disclosure, showing a single exemplary pixel area thereof, FIG. 2 is a partial cross-sectional view of the LCD panel of FIG. 1, as seen along the lines of the section I-I′ taken therein, and FIG. 3 is an enlarged plan view of a slit pattern of a pixel electrode of the LCD panel of FIG. 1.

Referring first to FIGS. 1 and 2, the first exemplary LCD panel 300 includes a thin film transistor substrate 100, a color filter substrate 200 facing the thin film transistor substrate 100, and a layer of a liquid crystal material 310 interposed therebetween.

The thin film transistor substrate 100 includes: a plurality of parallel first gate lines 121 extending in a first direction, e.g., in a horizontal or lateral direction, on a first insulating substrate 110; a plurality of parallel second gate lines 125 extending in the first direction between the first gate lines 121; a plurality of parallel data lines 160 extending in a direction, e.g., a vertical or longitudinal direction, so as to intersect the first and second gate lines 121 and 125; a pixel electrode 180 disposed in a pixel area defined at the intersection of a first gate line 121 and a data line 160; a first thin film transistor T1 connected to the first gate line 121, the data line 160 and the pixel electrode 180; and a second thin film transistor T2 connected to the second gate line 125, the data line 160 and a direction control electrode 163.

A first gate electrode 122 protrudes from a portion of the first gate line 121. The second gate line 125 extends between and is parallel to the first gate lines 121. A second gate electrode 126 protrudes from a portion of the second gate line 125. Optionally, a storage electrode line (not illustrated) may partially overlap the pixel electrode 180 to form a storage capacitor.

The first and second gate lines 121 and 125, and the optional storage electrode line (not illustrated) may be formed of one of aluminum (Al), neodymium (Nd), silver (Ag), chrome (Cr), titanium (Ti), tantalum (Ta), a molybdenum (Mo) or combinations thereof, or an alloy including at least one of the foregoing. Also, the first and second gate lines 121 and 125 and the storage electrode line (not illustrated) may have either a mono-layered structure or a multi-layered structure of a plurality of metal layers. That is, the first and second gate lines 121 and 125 and the optional storage electrode line may have a bi-layered structure comprising a first metal layer, such as Cr, Ti, Ta, Mo or the like, having excellent physical and chemical characteristics, and a second metal layer, such as an Al-based or an Ag-based metal layer, with low specific resistance.

As illustrated in FIG. 2, a gate insulating layer 130 is disposed over the entire surface of the substrate 100, including over the first and second gate lines 121 and 125 and the optional storage electrode line. The gate insulating layer 130 may comprise a single-layered or a multi-layered structure of silicon oxide (SiO2) or silicon nitride (SiNx).

A first active layer 141 and a second active layer 145, both of which are formed of a semiconductor material, such as amorphous silicon, are disposed on the gate insulating layer 130 on the first and second gate electrodes 122 and 126, respectively. A first ohmic contact layer 151 and a second ohmic contact layer 152 are disposed on the first active layer 141 and the second active layer 145, respectively. The first and second ohmic contact layers 151 and 152 are formed of a material such as silicide or n+ hydrogenated amorphous silicon highly doped with n-type impurities. The first and second ohmic contact layers 151 and 155 may be removed from channel portions respectively located between a first source electrode 161 and a first drain electrode 162, and between a second source electrode 165 and a second drain electrode 166.

The data line 160 is disposed on the gate insulating layer 130. The first source electrode 161 and the first drain electrode 162 protruding from the data line 160 are formed on the first ohmic contact layer 151. The second source electrode 165 and the second drain electrode 166 protruding from the data line 160 are formed on the second ohmic contact layer 155. The direction control electrode 163 is formed simultaneously with the data line 160 in the pixel area.

As illustrated in the single exemplary pixel area of FIG. 1, the data line 160 extends in a direction intersecting the first and second gate lines 121 and 125, that is, in a vertical or longitudinal direction. The pixel area is defined by the intersection of the data line 160 and the first gate line 122. The first source electrode 161 protrudes from the data line 160 and, as illustrated in FIG. 2 extends onto the first ohmic contact layer 151, and the second source electrode 165 protrudes from the data line 160 and extends onto the second ohmic contact layer 155. The first drain electrode 162 is disposed on the first ohmic contact layer 151 and is spaced apart from the first source electrode 161. The second drain electrode 166 is disposed on the second ohmic contact layer 155 and is spaced apart from the second source electrode 165.

As illustrated in FIG. 1, the direction control electrode 163 is formed in the pixel area, and includes a portion disposed parallel to the data line 160 and portion oblique thereto, and has a structure that is symmetrical about a horizontal line through its center. More specifically, the direction control electrode 163 includes: a vertical portion 163a disposed adjacent and parallel to the data line 160; a horizontal portion 163b extending perpendicularly from the center of the vertical portion 163a and toward an adjacent pixel; first oblique portions 163c respectively connected to and extending obliquely from each end of the vertical portion 163a; and second oblique portions 163d respectively extending from one end of the horizontal portion 163b in an oblique direction and respectively disposed parallel to the first oblique portions 163b. Also, a portion of the direction control electrode 163 may optionally overlap a portion of a storage electrode line (not illustrated). A portion of the direction control electrode 163 is included in a second thin film transistor T2 so that the direction control electrode 163 may serve as a second drain electrode 166.

At least a portion of a slit pattern 190 of the pixel electrode 180 overlaps the first and second oblique portions 163c and 163d of the direction control electrode 163 to form multi-domains in which liquid crystal molecules are respectively aligned in different orientations by an electric field generated by the direction control electrode 163. If the pixel electrode 180 does not include the slit pattern 190, and hence, the direction control electrode 163 is completely covered by the pixel electrode 180, the electric field generated by the direction control electrode 163 is ineffective. That is, the electric field becomes weak, and multi-domains having liquid crystal molecules respectively aligned in different orientations within the corresponding single pixel cannot be formed. For this reason, the direction control electrode 163 may be designed to at least partially overlap the slit pattern 190 of the pixel electrode 180.

As illustrated in FIG. 1, the first thin film transistor T1 is formed to include the first gate electrode 122, the first source electrode 161 extending from the adjacent data line 160, and the first drain electrode 162 connected to the pixel electrode 180. The second thin film transistor T2 for the direction control electrode is formed to include the second gate electrode 126, the second source electrode 165 extending from the data line 160, and the second drain electrode connected to the direction control electrode 163. The first thin film transistor T1 is disposed at an intersection of the data line 160 and the first gate line 121, and applies a predetermined voltage to the pixel electrode 180 to realign liquid crystal molecules. The second thin film transistor T2 is disposed at an intersection of the data line 160 and the second gate line 125, and applies a predetermined voltage to the direction control electrode 163 to form an electric field.

As illustrated in FIG. 2, a passivation layer 170 having a uniform thickness is disposed over the entire insulating surface including the first and second gate lines 121 and 125, the data line 160 and the direction control electrode 163. The passivation layer 170 may be an inorganic insulating layer or an organic insulating layer. The inorganic insulating layer includes a silicon oxide layer and a silicon nitride layer. The organic insulating layer may be photosensitive, and may have a dielectric constant of 4 or less. Also, a contact hole 181 is disposed in a predetermined area of the passivation layer 170 to expose a predetermined area of the first drain electrode 162.

The pixel electrode 180 is disposed on the passivation layer 170. The pixel electrode 180 is formed of a transparent conductive material, such as indium tin oxide (ITO) or indium zinc oxide (IZO). The pixel electrode 180 is electrically connected to the first drain electrode 162 through the contact hole 181. The pixel electrode 180 includes the slit pattern 190 that divides one pixel into a plurality of areas so as to achieve a wide viewing angle in the host LCD.

As illustrated in FIG. 3, the slit pattern 190 includes a first slit pattern portion 191 extending parallel to the gate line 121 and dividing the pixel electrode 180 into symmetrical upper and lower portions, and second to fourth slit pattern portions 192, 193 and 194 that are obliquely formed and have a symmetric structure with respect to the first slit pattern portion 191. The second slit pattern portion 192 is placed immediately adjacent to the first slit pattern portion 191, and the third and fourth slit patterns 193 and 194 are sequentially disposed parallel to the second slit patterns 192 and spaced apart from each other at predetermined intervals.

As illustrated in FIG. 1, the direction control electrode 163 may at least partially overlap the first slit pattern portion 191, the second slit pattern portion 192, and the fourth slit pattern portion 194. Such a configuration enables an electric field from the direction control electrode 163 to be appropriately applied, so that multi-domains in which liquid crystal molecules have respectively different orientations can be implemented. As a result, the host LCD exhibits a wide viewing angle.

The slit pattern 190 of the pixel electrode 180 is not limited to the particular embodiment described, but may have various other shapes and configurations.

As illustrated in FIG. 2, the exemplary color filter substrate 200 may include a black matrix 220, a color filter 230, an overcoat layer 240 and a common electrode 250, all disposed on a second insulating substrate 210.

The black matrix 220 is disposed in areas other than that occupied by the pixel area so as to prevent light leakage from areas other than the pixel area. The black matrix 220 also prevents light interference between adjacent pixel areas. That is, the black matrix 220 includes an aperture exposing an area in which the pixel electrode 180 of the thin film transistor substrate 100 resides. In general, the black matrix 220 is formed of a photosensitive organic material including a black pigment comprising, e.g., carbon black or titanium oxide.

Repetitively disposed red, green and blue filters having boundaries defined the black matrix 220 form the color filter 230. The color filter 230 imbues light that has passed through the liquid crystal layer 300 from a light source with colors. The color filter 230 may be formed of a photosensitive organic material.

The overcoat layer 240 is disposed on the color filter 230 and on the portions of the black matrix 220 not covered with the color filter 230. The overcoat layer 240 serves to planarize the color filter 230, protect the color filter 230 and to provide insulation between upper and lower conductive layers. The overcoat layer 240 may be formed of an acrylic epoxy material.

The common electrode 250 is disposed on the overcoat layer 240. The common electrode 250 is formed of a transparent conductive material, such as ITO or IZO. The common electrode 250, together with the pixel electrode 180 of the thin film transistor substrate 100, applies a voltage to the liquid crystal layer 310.

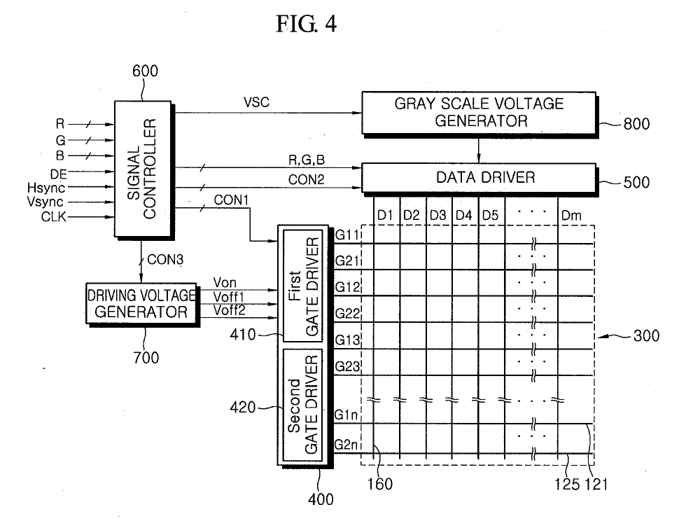

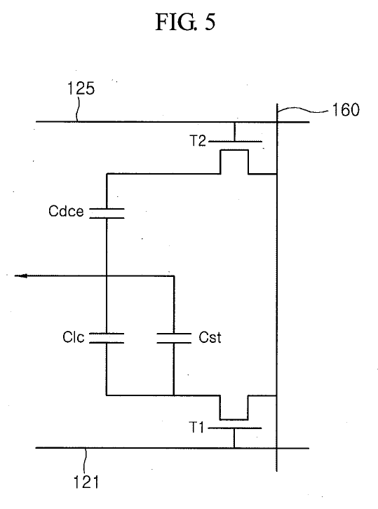

In the exemplary LCD panel 300 of FIG. 1 described above, the same gate-on voltage Von and different gate-off voltages Voff are applied to the first gate line 121 and the second gate line 126. A method for driving the LCD panel 300 is described below with reference to FIGS. 4 and 5.

FIG. 4 is a functional block diagram of an exemplary LCD incorporating the LCD panel 300 of FIG. 1, and FIG. 5 is an equivalent circuit diagram of a single pixel thereof.

Referring to FIGS. 4 and 5, the exemplary LCD includes the LCD panel 300, a gate driver 400 and a data driver 500 connected to the LCD panel 300, a gray scale voltage generator 800 connected to the data driver 500, a driving voltage generator 700 connected to the gate driver 400, and a signal controller 600 operative to control the foregoing elements.

The LCD panel 300 includes: a plurality of gate lines G11 through G1n spaced apart from each other; a plurality of second gate lines G21 through G2n spaced apart from the first gate lines G11 through G1n and disposed parallel to the first gate lines G11 through G1n; a plurality of data lines D1 through Dm intersecting the first gate lines G11 through G1n; and a plurality of pixels arranged in a matrix form and connected to the first gate lines G11 through G1n, the second gate lines G21 through G2n and the data lines D1 through Dm. The first and second gate lines G11 through G1n and G21 through G2n transfer a gate signal such as a gate-on voltage Von and first and second gate-off voltages Voff1 and Voff2. The data line D1 through Dm transfer data signals.

As illustrated in FIG. 5, each pixel includes: the first thin film transistor T1 connected to the first gate line 121 and the data line 160; the second thin film transistor T2 connected to the second gate line 125 and the data line 160; a liquid crystal capacitor Clc and a storage capacitor Cst connected to the first thin film transistor T1; and a direction control capacitor Cdce connected to the second thin film transistor T2.

In the first thin film transistor T1, the first gate electrode 122 is connected to the first gate line 121, the first source electrode 161 is connected to the data line 160, and the first drain electrode 162 is connected to the liquid crystal capacitor Clc and the storage capacitor Cst. In the second thin film transistor T2, a gate terminal is connected to the second gate line 125, the second source electrode 165 is connected to the data line 160, and the second drain electrode 166 is connected to the direction control capacitor Cdce. The liquid crystal capacitor Clc is formed by the pixel electrode 180 and the common electrode 250 with the liquid crystal layer 310 disposed therebetween. The storage capacitor Cst is formed by the storage electrode line (not illustrated) and the pixel electrode 180 with the gate insulating layer 130 disposed therebetween. Also, the direction control capacitor Cdce is formed by the direction control electrode and the common electrode 250 with the liquid crystal layer 310 disposed therebetween. Accordingly, the pixel electrode 180 is connected to the first thin film transistor T1, and the direction control electrode 163 is connected to the second thin film transistor T2. The common electrode 250 is formed over the entire surface of an associated color filter substrate 200, and receives a common voltage Vcom.

To implement a color display, each pixel uniquely displays one of a plurality primary colors (space division) or displays one of a plurality primary colors alternately with time (time division) such that the sum of the primary colors with respect to space or time can implement a desired color. For example, the primary colors may be the three primary colors of red, green and blue.

The signal controller 600 receives image signals corresponding to R, G and B and control signals controlling display of the image signal from an external graphic controller (not illustrated). Examples of the control signals include a vertical synchronous signal Vsync, a horizontal synchronous signal Hsync, a main clock CLK and a data enable signal DE. The signal controller 600 generates, e.g., a gate control signal CON1, a data control signal CON2, a voltage generation control signal CON3 and a voltage selection control signal VSC by using the received image signals R, G and B and the control signals. In addition, the signal controller 600 processes the image signals R, G and B so as to be suitable for operating of the LCD panel 300. The gate control signal CON1 is input to the gate driver 400, and the data control signal CON2 and the processed image signals R, G and B are input to the data driver 500. Further, the voltage generation control signal CON3 is input to the driving voltage generator 700.

The gray scale voltage generator 800 generates a plurality of gray scale voltages associated with the brightness of a pixel. The gray scale voltage generator 800 generates first and second sub-gray-scale voltages having different potentials for each pixel, and supplies the first and second sub-gray-scale voltages for each pixel to the data driver 500 according to the voltage selection control signal VSC of the signal controller 600.

According to the data control signal CON2, the data driver 500 sequentially receives image signals R, G and B corresponding to the pixels of one row, and selects first and second sub-gray scale voltages corresponding to each image signal from the plurality of gray scale voltages, thereby converting the image signal into first and second data signals. Then, the data driver 500 supplies the first and second data signals through the data lines D1 through Dm. The first data signal has a higher potential than the second data signal. The first and second data signals are applied to the direction control electrode 163 and the pixel electrode 180 through the same data line D1 through Dm at different times.

The driving voltage generator 700 generates a gate-on voltage Von and first and second gate-off voltages Voff1 and Voff2 for turning on/off the first and second thin film transistors T1 and T2 according to the voltage generation control signal CON3 of the signal controller 600.

The gate driver 400 includes a first gate driver 410 connected to the first gate lines G11 through G1n, and a second gate driver 420 connected to the second gate lines G21 through G2n. A gate-on voltage Von and a first gate-off voltage Voff1 are applied to the respective first gate lines G11 to G1n through the first gate driver 410. The gate-on voltage Von and a second gate-off voltage Voff2 having a different potential than the first gate-off voltage Voff1 are applied to the respective second gate lines G21 to G2n through the second gate driver 420. The first and second gate drivers 410 and 420 may be driven with a time difference therebetween. The first gate driver 410 may be driven after the second gate driver 420 is driven. That is, the gate signal may be applied first to the second gate lines G21 through G2n and then to the first gate lines G11 through G1n.

The control and driver components 400, 500, 600, 700 and 800 may be implemented in a single integrated circuit (IC) chip and may be mounted directly on the LCD panel 300. Alternatively the control and driver components 400, 500, 600, 700 and 800 may be respectively mounted on separate printed circuit boards (PCBs) and electrically connected through a flexible printed circuit board (FPCB). Also, the control and driver components 400, 500, 600, 700 and 800 may be integrated onto the LCD panel, together with the first gate lines G11 through G1n, the second gate lines G21 through G2n, the data lines D1 through Dm, and the first and second thin film transistors T1 and T2.

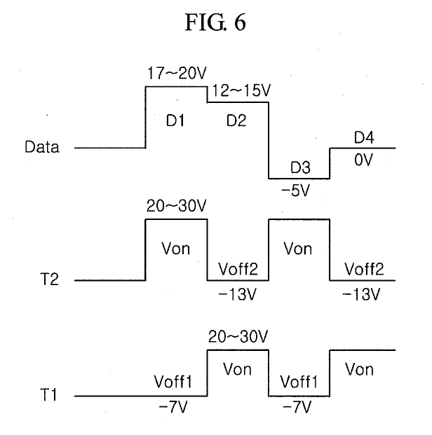

A driving method using the LCD having the structure described above is described below with reference to the waveform diagram of FIG. 6. In FIG. 6, a first data signal D1 is a data signal that is applied to the direction control electrode 163 through the second thin film transistor T2 in a positive (+) state, and a second data signal D2 is a data signal that is applied to the pixel electrode 180 through the first thin film transistor T1 in a positive (+) state. Also, a third data signal D3 is a data signal that is applied to the direction control electrode 163 through the second thin film transistor T2 in a negative (−) state, and a fourth data signal D4 is a data signal that is applied to the pixel electrode 180 through the first thin film transistor T1 in a negative (−) state. A gate-on voltage Von is a gate signal respectively applied to the first and second thin film transistors T1 and T2. The potentials of the gate-on voltages Von applied to the first and second thin film transistors T1 and T2 are the same. First and second gate-off voltages Voff1 and Voff2 are gate signals that are respectively applied to the first and second thin film transistors T1 and T2, and have different potentials from each other.

The gate-on voltage Von is applied sequentially to the second gate line G21 through G2n and the first gate line G11 through G1n to sequentially turn on the second and first thin film transistors T2 and T1. The potential of gate-on voltage Von may be in a range of, for example, 20V to 25V. When the polarity of a data signal is in a (+) state, the potential of the first data signal D1 is at least 5V higher than that of the second data signal D2. For example, if the second data signal D2 is from about 12V to about 15V, then the first data signal D1 is from about 17V to about 20V. Thus, the second data signal D2 and the first data signal D1 are respectively applied to the direction control electrode 163 and the pixel electrode 180 through the second and first thin film transistors T2 and T1 with a time difference.

As the second and first gate-off voltages Voff2 and Voff1 are applied with the time difference, the second and first thin film transistors T2 and T1 are respectively turned off. The direction control electrode 163 and the pixel electrode 180 respectively maintain the potential of the first data signal D1 and the potential of the second data signal D2. Accordingly, if a common voltage of 0V is applied to the common electrode 250, the voltage difference between the direction control electrode 163 and the common electrode 250 becomes higher than the voltage difference between the pixel electrode 180 and the common electrode 250, thereby generating an electric field that is almost perpendicular to the surfaces of the color filter substrate 200 and the thin film transistor substrate 100 disposed below the direction control electrode 163. In response to the electric field, the molecules of the liquid crystal layer change their orientations so that their long axes are arranged perpendicular to the direction of the electric field. The slit pattern portions 191, 192, 193 and 194 distort the electric field to create a horizontal component that determines the angles of inclination of the liquid crystal molecules. The horizontal component of the electric field is substantially perpendicular to the slit pattern 190 and the pixel electrode 180, and oriented toward the inside or outside of the pixel electrode 180, depending on the polarity of the voltage of the pixel electrode 180. For example, if the voltage of the pixel electrode 180 is higher than the common voltage Vcom, the horizontal component is oriented toward the outside of the pixel electrode 180. Accordingly, the liquid crystal molecules on the respective regions of the pixel electrode 180 divided by the slit pattern portions 191, 192, 193 and 194 are respectively aligned to have different orientations, so that multi-domains can be implemented and the LCD exhibits a wide viewing angle.

Thereafter, the polarity of the data signal is changed to a (−) state. In the (−) state, a potential of the third data signal D3 is lower than that of the fourth data signal D4 by approximately 5V. For example, the third data signal D3 may be applied with a potential of −5V, and the fourth data signal D4 may be applied with a potential of 0V. At this time, the gate-on voltage is applied sequentially to the second gate line G21 through G2n and the first gate line G1 through G1n to sequentially turn on the second and first thin film transistors T2 and T1. Accordingly, the third data signal D3 and the fourth data signal D4 are respectively applied to the direction control electrode 163 and the pixel electrode 180 through the second and first thin film transistors T2 and T1.

Also, the second and first gate-off voltages Voff2 and Voff1 having different potentials are applied with a time difference to turn off the second and first thin film transistors T2 and T1, respectively. Then, the direction control electrode 163 and the pixel electrode 180 maintain the potential of the third data signal D3 and the potential of the fourth data signal D4. The first and second gate-off voltages Voff1 and Voff2 have potentials of −7V and −13V, respectively.

Accordingly, in a (+) state, the difference between the voltage of the direction control electrode 163 and the second gate-off voltage Voff2 is in the range of from about 30V to about 33V, which is large enough to prevent a leakage current in the second thin film transistor T2. Further, in a (−) state, the difference between the voltage of the direction control electrode 163 and the second gate-off voltage Voff2 is 8V, which is large enough to prevent a leakage current in the second thin film transistor T2.

The second gate-off voltage Voff2 is constrained to be lower than the first gate-off voltage Voff1 in a (−) state considering the voltage of the direction control electrode 163. The second gate-off voltage Voff2 may be applied as a negative (−) voltage obtained by adding the first gate-off voltage Voff1 to 1/2 to 3/2 of the negative voltage applied to the direction control electrode 163, as expressed by the following Equation 1. For example, if the first gate-off voltage Voff1 is −7V, and a voltage applied to the direction control electrode 163 is −5 Vin a (−) state, the second gate-off voltage Voff2 ranges from −9.5 V to −14.5 V.

$$Voff 2 = Voff 1 + ( \frac{1}{2} to \frac{3}{2} ) Vdce \qquad [ Equation 1 ]$$

The voltages described above are merely examples given for explaining the exemplary embodiment. The second gate-off voltage Voff2 may be set differently depending on a characteristic of the second thin film transistor T2. Further, the voltages applied to the pixel electrode 180 and the direction control electrode 163 may be set differently depending on the particular driving range desired.

Various driving methods may be used in the place of the above-described method of applying data signals having different potentials to the direction control electrode and the pixel electrode through the same data line. For example, the direction control electrode may overlap the storage electrode line so as to form a direction control capacitor. In this case, the pixel electrode forms a liquid crystal capacitor together with the common electrode, and the pixel electrode also partially overlaps the storage electrode line to form a storage capacitor. Also, the direction control electrode and the common electrode form another liquid crystal capacitor. An overlapping area between the storage electrode line and the direction control electrode may be greater than an overlapping area between the storage electrode line and the pixel electrode. After a predetermined voltage is applied to the storage electrode line and the same voltage is applied to the direction control electrode and the pixel electrode, the voltage of the storage electrode line is raised. In this way, the capacitance of the direction control capacitor increases and becomes greater than the capacitance of the storage capacitor. This affects the liquid crystal capacitor defined over the direction control capacitor, and the inclination angles of the liquid crystal molecules can thereby be controlled.

### Second Exemplary Embodiment

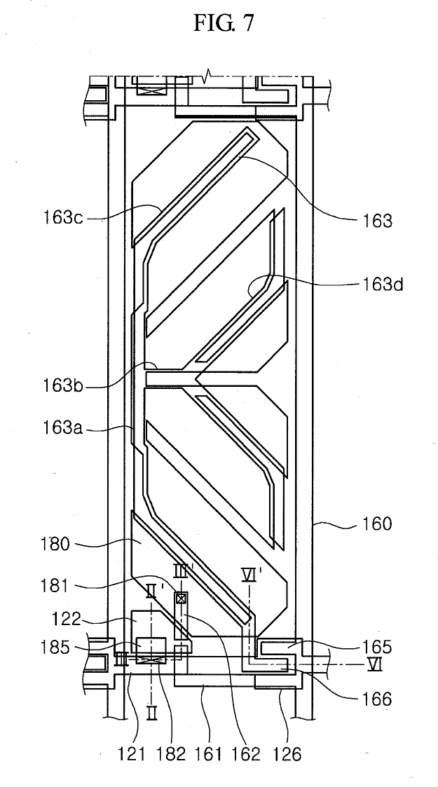

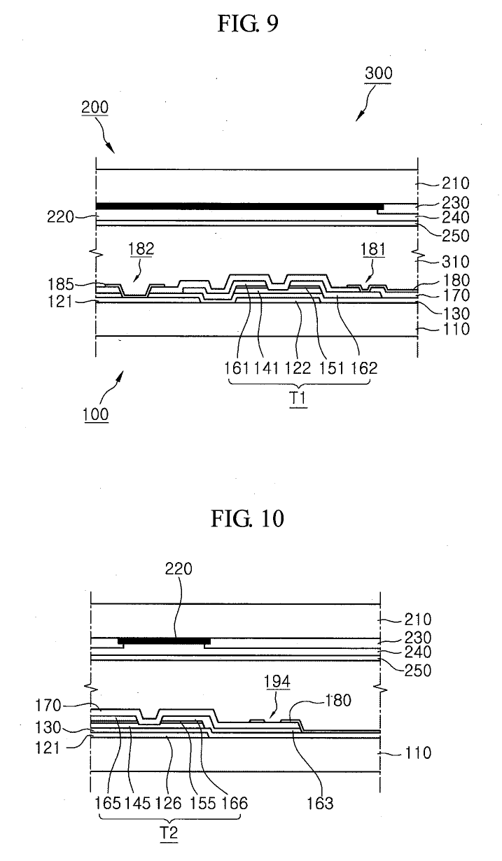

In the first exemplary embodiment of FIG. 1, thin film transistors are respectively disposed on two gate lines, and different gate voltages are applied to the thin film transistors. However, in another exemplary embodiment, different gate voltages are applied through one gate line. This is described below with reference to FIGS. 7 through 10.

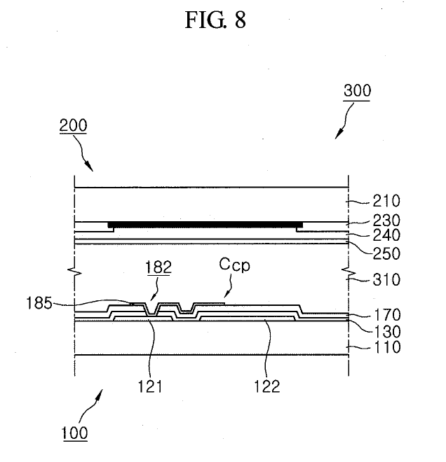

FIG. 7 is a partial plan view of a second exemplary embodiment of an LCD panel 300 in accordance with the present disclosure, showing a single exemplary pixel area thereof and FIGS. 8-10 are partial cross-sectional views of the exemplary LCD panel of FIG. 7, as respectively seen along the lines of the sections II-II′, III-III′ and IV-IV′ taken therein.

In the second exemplary LCD panel 300, a gate voltage of a gate line 121 is directly applied to a second gate electrode 126 of a second thin film transistor T2 connected to a direction control electrode 163. A potential is applied to a first gate electrode 122 of a first thin film transistor T1 connected to a pixel electrode 180, wherein the potential is obtained by adjusting a gate voltage of the gate line 121 according to a coupling ratio of a first gate electrode 122 separated from the gate line 121 and a dummy electrode 185 separated from the pixel electrode 180. That is, a voltage obtained by dropping the gate voltage of the gate line 121 according to the coupling ratio of the first gate electrode 122 and the pixel electrode 180 is applied to the first gate electrode 122. Accordingly, the coupling ratio of the first gate electrode 122 and the dummy electrode 185 is adjusted considering a voltage drop of a voltage applied to the first gate electrode 122 with respect to the gate voltage applied to the second gate electrode 126 through the gate line 121. An LCD in accordance with this second exemplary embodiment is described below.

Referring to FIGS. 7 through 10, the second exemplary LCD panel 300 includes a thin film transistor substrate 100, a color filter substrate 200 facing the thin film transistor substrate 100, and a layer of a liquid crystal material 310 disposed therebetween.

The thin film transistor substrate 100 includes a plurality of gate lines 121 extending in a first direction on a first insulating substrate 110, a plurality of data lines 160 extending so as to intersect the gate lines 121, a pixel electrode 180 formed in each of the pixel areas defined at the intersections of the gate lines 121 and the data lines 160, a first thin film transistor T1 connected to a first gate electrode 122, the data line 166 and the pixel electrode 180, and a second thin film transistor T2 connected to a second gate electrode 125, the data line 160 and a direction control electrode 163.

As illustrated in the exemplary single pixel area of FIG. 7, the gate line 121 may extend, for example, in a horizontal or lateral direction. The first gate electrode 122 is separated from the gate line 121, and the second gate electrode 126 protrudes from a portion of the gate line 121. The first gate electrode 122 is disposed within the pixel area and spaced apart from the gate line 121, and formed so as not to overlap the pixel electrode 180. A storage electrode line (not illustrated) may also be provided and may partially overlap the pixel electrode 180 to form a storage capacitor Cst.

As illustrated in FIG. 8, a gate insulating layer 130 is disposed over the entire surface of the substrate 110, including over the gate line 121. A first active layer 141 and a first ohmic contact layer 151 are disposed on a portion of the first insulating layer 130 disposed over the first gate electrode 122. A second active player 145 and a second ohmic contact layer 155 are disposed over a portion of the gate insulating layer 130 disposed over the second gate electrode 126.

The data line 160 extends so as to intersect the gate line 121, i.e., in a vertical or longitudinal direction, and a pixel area is defined at the intersection of the data line 160 and the data line 121. First and second source electrodes 161 and 165 extend from the data line 160 onto the first and second ohmic contact layers 151 and 155, respectively. Also, a first drain electrode 162 is disposed on the first ohmic contact layer 151 and spaced apart from the first source electrode. Thus, the first gate electrode 122, the first source electrode 161, and the first drain electrode 162 connected to the pixel electrode 180 form the first thin film transistor T1.

The direction control electrode 163 is disposed in the pixel area, and may be disposed on the same layer as the data line 160. The direction control electrode 163 includes a vertical portion 163a, a horizontal portion 163b, and respectively symmetrical first and second oblique portions 163c and 163d. A portion of the direction control electrode 163 serves as a second drain electrode 166 of the second thin film transistor T2. Thus, the second gate electrode 126, the second source electrode 165, and the second drain electrode 166 connected to the direction control electrode 163 form the second thin film transistor T2. The first and second oblique portions 163c and 163d of the direction control electrode 163 respectively overlap portions of the slit pattern 190 (see FIG. 3) of the pixel electrode 180.

A passivation layer 170 is disposed over the entire first insulating substrate 110, including over the gate line 121, the data line 160 and the direction control electrode 163. First and second contact holes 181 and 182 respectively exposing a predetermined area of the first drain electrode 162 and a portion of the gate line 121 are respectively disposed in predetermined areas of the passivation layer 170.

The pixel electrode 180 is disposed on the passivation layer 170. The pixel electrode 180 is electrically connected to the first drain electrode 162 through the first contact hole 181. The slit pattern 190 is formed in the pixel electrode 180 and at least partially overlaps the direction control electrode 163. A dummy electrode 185 is also disposed on the passivation layer 170. The dummy electrode 185 is separated from the pixel electrode 180 and electrically connected to the gate line 121 through the second contact hole 182. The dummy electrode 185 together with the first gate electrode 122 forms a coupling capacitor having the gate insulating layer 130 and the passivation layer 170 therebetween. That is, the pixel electrode 180 and the dummy electrode are disposed in the same layer.

The dummy electrode 185 is connected to the gate line 121, and overlaps the first gate electrode 122 to form a coupling capacitor. The capacitance of the coupling capacitor is adjusted according to the area of the overlap between the dummy electrode 185 and the first gate electrode 122. The coupling capacitance increases as the area of overlap between the dummy electrode 185 and the first gate electrode 122 increases and decreases as the area of overlap decreases. Also, the coupling capacitance may be adjusted according to the parasitic capacitance between the first gate electrode 122 and the first source electrode 161, the parasitic capacitance between the first gate electrode 122 and the first drain electrode 162, and the liquid crystal capacitance. However, the aforementioned parasitic and liquid crystal capacitances may be fixed. Therefore, by adjusting the area of overlap between the dummy electrode 185 and the first gate electrode 122, the potential of the coupling capacitor can be adjusted to be lower than the gate voltage applied through the gate line 121, and thus the potential of the first gate electrode 122 can be adjusted. That is, the potential of the first gate electrode 122 is calculated by the following Equation 2:

$$Vg 1 = Vg \frac{Ccp}{Ccp + Clc + Cgs + Cgd} \qquad [ Equation 2 ]$$

where Vg denotes a voltage applied to the gate line 121, Vg1 denotes a potential of the first gate electrode 122, Ccp denotes coupling capacitance of the first gate electrode 122 and the dummy electrode 185, Clc denotes the liquid crystal capacitance, Cgs is the parasitic capacitance between the first gate electrode 122 and the first source electrode 161, and Cgd denotes the parasitic capacitance between the first gate electrode 122 and the first drain electrode 162. Also, the voltage being applied to the gate line 121 is a gate signal, i.e., a gate-on voltage Von and a gate-off voltage Voff.

The voltage applied to the second gate electrode 126 of the second thin film transistor T2 is supplied as the gate voltage through the gate line 121. The coupling capacitance Ccp can be adjusted by adjusting the area of overlap of the first gate electrode 122 and the dummy electrode 185, whereby a voltage applied to the second gate electrode 122 can be adjusted.

For example, the area of overlap between the first gate electrode 122 and the dummy electrode 185 is adjusted to adjust the coupling capacitance Ccp, so that the ratio of the potential of the first gate electrode 122 to the voltage of the second gate electrode 125 becomes 0.6:1. Thereafter, a second gate-on voltage Von2 of 33V and a second gate-off voltage Voff2 of −12V are applied to the second gate electrode 125. That is, the second gate-on voltage Von2 of 33V and the second gate-off voltage Voff2 of −12 V are applied to the second gate electrode 125 of the second thin film transistor T2. Conversely, a first gate-on voltage Von1 of 19.8V and a first gate-off voltage Voff1 of −7.2 V are applied to the first gate electrode 122 of the first thin film transistor T1. If the voltage difference between the direction control electrode 163 and the pixel electrode 180 is 5V, then the voltage applied to the direction control electrode 163 is higher than that applied to the pixel electrode 180 by 5V in a (+) state and by −5 V in a (−) state. In such a case, when a voltage of the direction control electrode 163 is −5V in a (−) negative state, the voltage difference between the second gate-off voltage Voff2 and the direction control electrode 163 is 7V, which is sufficiently large to prevent a leakage current in the second thin film transistor T2.

The difference between the second gate-off voltage Voff2 and the first gate-off voltage Voff1 may be controlled within a range of 1/2 to 3/2 of the negative voltage applied to the direction control electrode 163, i.e., the voltage applied to the direction control electrode 163 in a (−) state. That is, the overlapping area of the first gate electrode 122 and the dummy electrode 185 is adjusted such that the difference between the second gate-off voltage Voff2 and the first gate-off voltage Voff1 falls within a range of 1/2 to 3/2 of the negative voltage applied to the direction control electrode 163 in a (−) state, whereby the coupling capacitance Ccp can be adjusted.

### Third Exemplary Embodiment

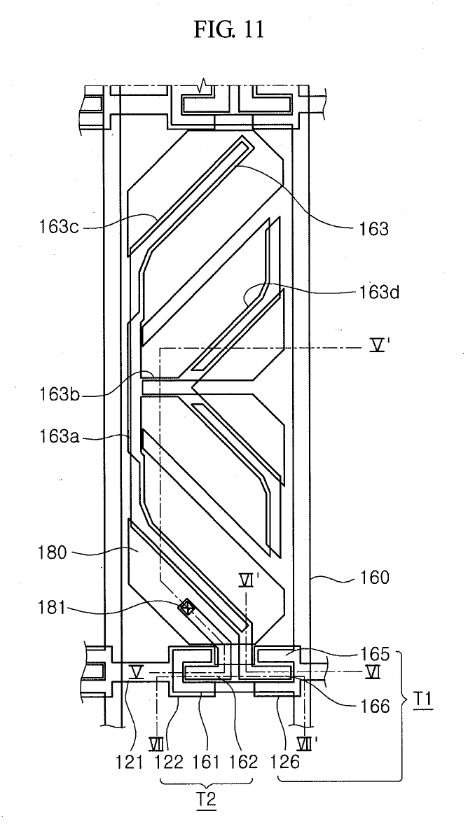

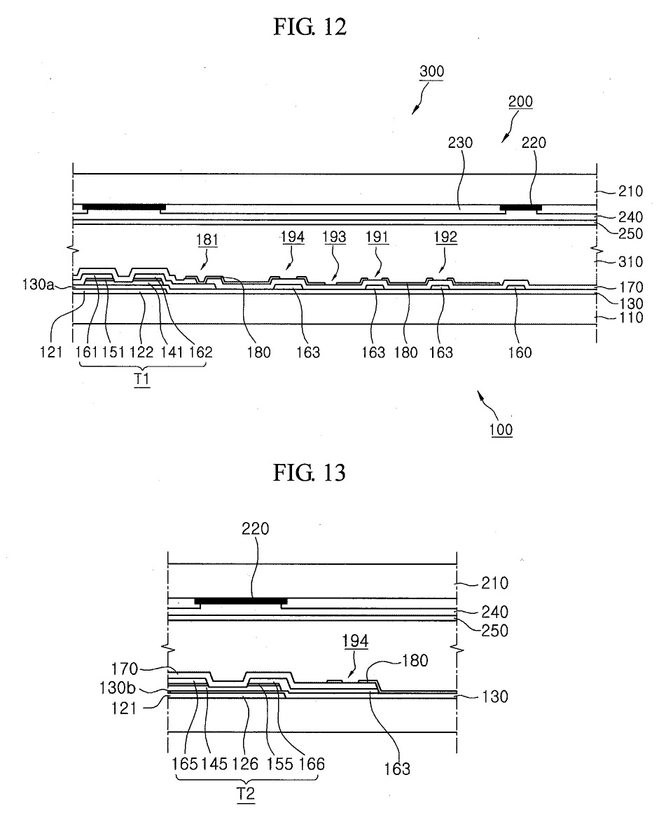

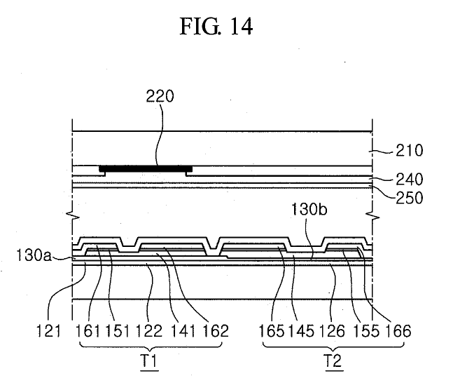

FIG. 11 is a partial plan view of a third exemplary embodiment of an LCD panel in accordance with the present disclosure, showing a single exemplary pixel area thereof, and FIGS. 12-14 are partial cross-sectional views of the third exemplary LCD panel of FIG. 11, as respectively seen along the lines of the sections V-V′, VI-VI′ and VII-VII′ taken therein.

In the third exemplary LCD panel 300 of FIG. 11, a first thin film transistor T1 for a pixel electrode and a second thin film transistor T2 for a direction control electrode are connected to a gate line 121 and a data line 160, respectively. A portion of a gate insulating layer 130 disposed on a first gate electrode 122 of the first thin film transistor T1 has thickness that is different from the thickness of another portion of the gate insulating layer 130 disposed on a second gate electrode 126 of the second thin film transistor T2. Specifically, the gate insulating layer 130 of the second thin film transistor T2 is thinner than the gate insulating layer 130 of the first thin film transistor T1. Thus, even if a gate signal having the same potential is applied to the associated gate line, the potential of the gate signal as applied to the first thin film transistor T1 will be lower than that applied to the second thin film transistor T2. Accordingly, the potential of the gate signal is raised and applied considering the potential drop of the gate signal, thereby increasing the difference between the gate signal and the voltage of the direction control electrode 163, thereby preventing leakage current in the second thin film transistor T2.

Referring to FIGS. 11, 12, 13 and 14, the LCD panel 300 includes a thin film transistor substrate 100, a color filter substrate 200 facing the thin film transistor substrate 100, and a liquid crystal layer 310 interposed therebetween.

The thin film transistor substrate 100 includes a plurality of gate lines 121 extending in one direction on a first insulating substrate 100, a plurality of data lines 160 extending so as to intersect the gate lines 121, a plurality of pixel areas defined by the intersections of the gate lines 121 and the data lines 160, each pixel area including an associated pixel electrode 180, a first thin film transistor T1 connected to the associated gate line 121, data line 160 and pixel electrode 180, and a second thin film transistor T2 connected to the associated gate line 121, data line 160 and an associated direction control electrode 163.

As illustrated in the exemplary single pixel area of FIG. 11, the gate line 121 may extend, for example, in a horizontal or lateral direction. First and second gate electrodes 122 and 126 protrude from portions of the gate line 121. A storage electrode line (not illustrated) may further be disposed on the substrate 110. The storage electrode line partially overlaps the pixel electrode 180 to form a storage capacitor Cst.

A gate insulating layer 130 is disposed over the entire first insulating substrate 110, including over the gate line 121. A portion of the gate insulating layer 130a disposed over the first gate electrode 122 is formed to have a thickness different from that of another portion of the gate insulating layer 130b disposed over the second gate electrode 126. That is, the portion of the gate insulating layer 130b disposed over the second gate electrode 126 is thinner than the portion of the gate insulating layer 130a disposed over the first gate electrode 122. To fabricate such a gate insulating layer 130, a mask for covering the second gate electrode 126 is formed on the second gate electrode 126, and then a gate insulating layer having a predetermined thickness is formed. Thereafter, the mask is removed, and then a gate insulating layer having another thickness is formed. Alternatively, after the gate insulating layer 130 is formed, a predetermined thickness of a portion of the gate insulating layer 130 over the second gate electrode 126 is etched by a photolithography process using a mask that exposes the portion of the gate insulating layer 130 over the second gate electrode 126.

A first active layer 141 and a second active layer 145 are respectively disposed over the portions of the gate insulating layer 130a and 130b having the different thicknesses. First and second ohmic contact layers 151 and 155 are respectively formed on the first and second active layers 141 and 145.

The data line 160 is formed to intersect the gate line 121. A first source electrode 161 and a first drain electrode 162 are disposed on the first ohmic contact layer 151, and a second source electrode 165 and a second drain electrode 166 are disposed on the second ohmic contact layer 155. The direction control electrode 163 is disposed in the pixel area defined at the intersection of the data line 160 and the gate line 121. A portion of the direction control electrode 163 serves as the second drain electrode 166 of the second thin film transistor T2. Thus, the first thin film transistor T1 includes the first gate electrode 122, the first source electrode 161 and the first drain electrode 162, and the second thin film transistor T2 includes the second gate electrode 126, the second source electrode 165 and the second drain electrode 166 connected to the direction control electrode 163.

A passivation layer 170 is disposed over the entire first insulating substrate 110, including over the gate line 121, the data line 160 and the direction control electrode 163. A contact hole 181 is disposed in a predetermined area of the passivation layer 170 to expose a predetermined area of the first drain electrode 162.

The pixel electrode 180 is disposed on the passivation layer 170, and is electrically connected to the first drain electrode 162.

When the portion of the gate insulating layer 130b disposed over the second electrode 126 is thinner than another portion of the gate insulating layer 130a disposed over the first gate electrode 122, an electric field applied to the second thin film transistor T2 is greater than an electric field applied to the first thin film transistor T1. This is because an electric field E is in proportion to a gate voltage Vg and in inverse proportion to a thickness d of an insulating layer as expressed in the following Equation 3:

$$E = \frac{Vg}{d} \qquad [ Equation 3 ]$$

For example, if a gate voltage Vg is −7V and the portions of the gate insulating layer 130a and 130b respectively disposed over the first and second gate electrodes 122 and 126 have respective thicknesses of 4500 Å and 3000 Å, then according to Equation 3, the electric field applied to the first thin film transistor T1 is −15.6 V/μm, and the electric field applied to the second thin film transistor T2 is −23V/μm. Thus, even if the same gate signal is applied, the electric fields respectively applied to the first and second thin film transistors T1 and T2 are different. For example, if a voltage higher by +5V/−5V than that applied to the pixel electrode 180 is applied to the direction control electrode 163 in a (+)/(−) state, and a voltage applied to the direction control electrode in a (−) state is −5 V, a voltage difference between the second gate-off voltage Voff2 and the direction control electrode 163 is 18V, which is sufficiently large to pre-vent a leakage current in T2.

The thickness ratio of the portions of the gate insulating layer 130a and 130b respectively disposed over the first and second gate electrodes 122 and 126 may be controlled to fall within a range of from about 10:3 to about 10:9. For example, if the thickness of the portion of the gate insulating layer 130a disposed over the first gate electrode 122 is 5000 Å, the thickness of the portion of the gate insulating layer 130b disposed over the second gate electrode 126 is controlled to fall within a range of from about 1500 Å to about 4500 Å.

According to one exemplary embodiment described herein, a thin film transistor for a pixel electrode and a thin film transistor for a direction control electrode are configured on different gate lines, and gate-off voltages having different potentials are applied thereto. According to another exemplary embodiment, a thin film transistor for a pixel electrode and a thin film transistor for a direction control electrode are configured on one gate line, and the coupling capacitance between a gate electrode of the thin film transistor for the pixel electrode and a dummy electrode is adjusted. According to yet another exemplary embodiment, portions of a gate insulating layer have different thicknesses, and as a result, the electric field applied to a thin film transistor for a direction control electrode is made higher than that applied to a thin film transistor for a pixel electrode.

Accordingly, in a (−) state, a voltage difference between an electric field applied to the thin film transistor for the direction control electrode and a voltage of the direction control electrode increases, so as to prevent a leakage current in the thin film transistor for the direction control electrode. As a result, the direction control electrode can be sufficiently charged with an electric charge to implement stable multi-domains without having to applying a high voltage, thereby assuring a wide viewing angle in the host LCD. Further, no slit pattern need be formed in the common electrode, thereby simplifying processes and improving productivity.

As those of skill in this art will appreciate, many modifications, substitutions and variations can be made in the materials, constructions and methods of implementation of the novel LCDs of the present disclosure without departing from its spirit and scope. In light of this, the scope of the present disclosure should not be limited to that of the particular embodiments illustrated and described herein, as they are only by way of some examples thereof, but instead, should be fully commensurate with that of the claims appended hereafter and their functional equivalents.

What is claimed is:

1. A liquid crystal display (LCD), comprising:
parallel first and second gate lines extending in a first direction;
a data line extending in a direction so as to intersect the first and second gate lines;
a pixel electrode disposed at the intersection of the first gate line and the data line;
a direction control electrode insulated from the pixel electrode;
a first thin film transistor connected to the first gate line, the data line and the pixel electrode; and,
a second thin film transistor connected to the second gate line, the data line and the direction control electrode,
wherein different gate signals are respectively applied to the first and second gate lines.

2. The LCD of claim 1, wherein the first and second gate lines are formed simultaneously.

3. The LCD of claim 1, wherein the direction control electrode is formed simultaneously with the data line.

4. The LCD of claim 1, wherein the second thin film transistor comprises:
a second gate electrode connected to the second gate line;
a second source electrode branching out from the data line and disposed on the second gate electrode; and,
a second drain electrode branching out from the direction control electrode, partially overlapping the second gate electrode and spaced apart from the second source electrode.

5. The LCD of claim 1, further comprising:
a gate driver configured to apply gate signals to the first and second gate lines;
a data driver configured to apply data signals to the data line;
a driving voltage generator configured to generate the gate signals; and,
a signal controller configured to control the gate driver, the data driver and the driving voltage generator, respectively,
wherein the driving voltage generator generates the gate signals such that the gate signal applied to the second gate line has a higher potential than the gate signal applied to the first gate line.

6. The LCD of claim 5, wherein the gate driver controls the gate signals so that the gate signal is applied to the first gate line after the gate signal is applied to the second gate line.

7. The LCD of claim 5, wherein the data driver controls the data signals so that the data signals having different potentials are applied with a time difference therebetween.

8. The LCD of claim 5, wherein the gate signals comprise:
a gate-on voltage for turning on the first and second thin film transistors; and,
first and second gate-off voltages for respectively turning off the first and second thin film transistors,
wherein the second gate-off voltage is a negative voltage having an absolute value than is larger than the absolute value of the first gate-off voltage.

9. The LCD of claim 8, wherein the second gate-off voltage is less than the sum of the first gate-off voltage and 1/2 of a negative voltage applied to the direction control electrode.

10. A liquid crystal display (LCD), comprising:
a gate line extending in a first direction;
a data line extending in a direction so as to intersect the gate line;
a pixel electrode disposed at the intersection of the gate line and the data line;
a direction control electrode insulated from the pixel electrode;
a first thin film transistor connected to the gate line as a coupling capacitor; and,
a second thin film transistor connected to the gate line.

11. The LCD of claim 10, wherein the first thin film transistor comprises:
a gate electrode separated from the gate line and not overlapping the pixel electrode;
a source electrode partially overlapping the gate electrode and separated from the gate line; and,
a drain electrode partially overlapping the gate electrode, spaced apart from the source electrode and connected to the pixel electrode.

12. The LCD of claim 11, further comprising a dummy electrode connected to the gate line and partially overlapping the gate electrode to form a coupling capacitor.

13. The LCD of claim 12, wherein a potential depending on a coupling ratio of the gate electrode and the dummy electrode is applied to the gate electrode.

14. The LCD of claim 13, wherein a coupling ratio of the gate electrode and the dummy electrode is controlled such that a gate-off voltage applied to a gate electrode has a lower potential than a sum of a gate-off voltage applied to the gate electrode and 1/2 of a negative voltage applied to the direction control electrode.

15. A liquid crystal display (LCD), comprising:
a gate line extending in a first direction;
a data line extending in a direction so as to intersect the gate line;
a pixel electrode disposed at the intersection of the gate line and the data line;
a direction control electrode insulated from the pixel electrode;
a first thin film transistor connected to the gate line, the data line and the pixel electrode, and including a first gate insulating layer having a first thickness; and,
a second thin film transistor connected to the gate line, the data line and the direction control electrode, and including a second gate insulating layer having a second thickness,
wherein the first and second thicknesses are different from each other.

16. The LCD of claim 15, wherein the thickness of the first gate insulating layer is greater than the thickness of the second gate insulating layer.

17. The LCD of claim 16, wherein the respective thicknesses of the first and second gate insulating layers are controlled such that a gate-off voltage applied to the second thin film transistor has a lower potential than the sum of a gate-off voltage applied to the first thin film transistor and 1/2 of a negative voltage applied to the direction control electrode.

18. The LCD of claim 17, wherein the thickness of the second gate insulating layer is in a range of from about 30% to about 90% of the thickness of the first gate insulating layer.

19. A liquid crystal display (LCD), comprising:
a gate line extending in a first direction;
a data line extending in a direction so as to intersect the gate line;
a pixel electrode disposed at the intersection of the gate line and the data line;
a direction control electrode insulated from the pixel electrode;
a first thin film transistor connected to the gate line, the data line and the pixel electrode; and,
a second thin film transistor connected to the gate line, the data line and the direction control electrode,
wherein an absolute value of a gate signal applied to the second thin film transistor is higher than an absolute value of a gate signal applied to the first thin film transistor.
